(19) United States
(12) Patent Application Publication
(10) Pub. No.: US 2010/0082351 A1
(43) Pub. Date: Apr. 1, 2010

(54) UNIVERSAL REMOTE CONTROLLER AND CONTROL CODE SETUP METHOD THEREOF

(75) Inventor: Sung-Sub Lee, Anyang-Si (KR)

Correspondence Address: GIFFORD, KRASS, SPRINKLE,ANDERSON & CITKOWSKI, P.C, PO BOX 7021, TROY, MI, 48007-7021, US

(73) Assignee: SEOBY ELECTRONICS CO., LTD.

(21) Appl. No.: 12/523,079

(22) PCT Filed: Sep. 12, 2007
(86) PCT No.: PCT/KR2007/004401

§ 371 Date: Jul. 14, 2009

(30) Foreign Application Priority Data
Feb. 9, 2007 (KR) 10-2007-0013554

(51) Int. Cl. G10L 11/00

(52) U.S. Cl. 704/275; 341/176

(57) ABSTRACT

The present invention provides a universal remote controller that transmits and informs the learning of control codes, the setup of the control codes, and the setup of preference channels by voice commands, learns a voice command or key value input according to the voice command transmitted, and registers the leaned key value as the control code. A control codes setup method includes detecting input of a voice command or a specific key signal requesting a control codes setup in a standby mode, starting, when the voice command or specific key signal is detected, a control codes setup mode and transmitting a control codes setup method step by step by voice information, recognizing a voice command or key signal input by a user according to the voice information transmitted, and starting a standby mode after registering and storing the control codes matching with the recognized voice commands or key signals and transmitting voice information on the registering and storing of the control codes.

### TECHNICAL FIELD

The present invention relates to a universal remote controller. More particularly, the present invention relates to a universal remote controller that sets up control codes by transmitting a control codes setup and learning method of a device that will be controlled by voice information and recognizing a key value or a user's voice command input in accordance with the voice information, and a control codes setup method of the universal remote controller.

### BACKGROUND ART

Generally, in order to remote-control a variety of home appliances, such as a TV, a VCR, a cable set-top box, an audio system, a home automation system, and the like, a remote controller for each corresponding appliance is essentially used.

Therefore, there are many remote controllers for the respective home appliances in a home. That is, in order to remote-control a specific appliance, a user has to find the remote controller corresponding to the specific appliance among the plurality of remote controllers and then operate the desired function. This is troublesome for the user.

In addition, when the user loses a remote controller, the user cannot remote-control the corresponding appliance.

To overcome the above problems, a universal remote controller is provided that can control all home appliances, such as TV sets, VCRs, cable set-top boxes, audio systems, and home automation systems, even when they are made by different companies or are different models.

For example, as shown in FIG. 4, the universal remote controller includes a plurality of function keys.

That is, the universal remote controller includes appliance selection keys for selecting an appliance that will be controlled among a variety of appliances including TV, VCR, SAT, and AUDIO keys, a channel up/down key, a sound up/down key, a mute key, a screen adjusting key, a menu key, a sound output mode selection key, a variety of function keys selecting a function of the VCR, number keys (0-9) for selecting a channel, extending keys such as +10 or +20, preference keys FAV1 and FAV2 for the memory of channel numbers that are frequently used by themes, and the like.

In order to use the universal remote controller structured as described above, a process for setting up control codes of an appliance that will be controlled must be performed in advance.

According to a well-known method for setting up the control codes, the user finds out code numbers matching with control codes of an appliance that will be controlled in accordance with a method provided by a user manual of the universal remote controller and inputs the code numbers himself/herself using keys.

In addition, according to another method, the user sets up the control codes of the appliance that will be controlled by manually turning on power of an appliance that will be controlled, repeatedly stroking a specific key, e.g., a setup key, provided on the universal remote controller, and selecting a setup confirm when the power of the appliance reacts.

As described above, in order to set up the control codes of the appliance in the universal remote controller, a user manual must be utilized, which is troublesome for the user. In addition, when the user feels difficulty in understanding the user manual, the user must ask another person for help.

According to a using method of a well-known universal remote controller, one of the appliances is selected in the universal remote controller and a control codes setup mode is started by pushing a specific key for a predetermined time, after which the user finds out codes assigned to the appliance selected from the user manual and inputs the codes by himself/herself.

Therefore, since a plurality of complicated setting processes must be performed, it is very difficult and troublesome for the user to set up the control codes of the appliance that will be controlled.

### DISCLOSURE

### Technical Problem

### Technical Object

The present invention has been made in an effort to solve the above-described problems. It is an object of the present invention to provide a universal remote controller that is designed to conveniently set up control codes by transmitting a method of setting and learning control codes of a device that will be controlled by voice information and recognizing a key value or a user's voice command input in accordance with the voice information, and a control codes setup method thereof.

The present invention also provides a control codes setup method of a universal remote controller that can remote-control an appliance when a voice command that is input in accordance with voice information is not a preset control command but a command for selecting an operation of another appliance by storing the voice command in a memory region in which the control command is stored and reacting with the voice command input.

The present invention also provides a control codes setup method of a universal remote controller that can setup control codes by repeatedly learning a user's voice commands having different voice colors and accents by ages and provinces using a personal independent method to correct a recognition rate difference of a variety of voice commands according to voice properties such as voice level, accent by province, and the like, modeling an optimal value, and processing a voice difference between individuals as an identical key value by applying the optimal value.

### Technical Solution

To achieve the objects, an exemplary embodiment of the present invention provides a universal remote controller including a key input unit having at least one function key and number key, an oscillation unit oscillating at a predetermined frequency, a power unit supplying power to loads, a transceiver unit for transmitting and receiving control codes, and a display unit displaying an operational state. The universal remote controller further includes a voice memory storing voice data informing a control codes setup method, a sound detecting unit detecting a voice command, a voice recognition unit recognizing the voice command transmitted from the voice detecting unit, and a control unit that starts a control codes setup mode by recognizing the voice command or a key signal, transmits a setup of the control codes by voice information through a speaker, and stores the control codes matching the voice commands or key signals input by a user according to the voice information.

Another exemplary embodiment of the present invention: provides a control codes setup method of a universal remote controller including detecting input of a voice command or a specific key signal requesting control codes setup in a standby mode; starting, when the voice command or specific key signal is detected, a control codes setup mode and transmitting a control codes setup method step by step by voice information; recognizing a voice command or key signal input by a user according to the voice information transmitted; and starting a standby mode after registering and storing the control codes matching with the recognized voice commands or key signals and transmitting the voice information on the registering and storing of the control codes.

Still another exemplary embodiment of the present invention provides a control codes setup method of a universal remote controller including: starting a learning mode when a voice command or a key signal requesting control codes learning is detected in a standby mode, informing the start of the learning mode by voice information, and requesting a key input corresponding to the voice information; learning and storing a key value input according to the voice information and requesting input of the corresponding key at least one more time for reliability; determining if the key values that are repeatedly input are identical to each other; starting the standby mode after transmitting an error message when the key values that are repeatedly input are not identical and transmitting the key value and storing the key value as a learned value when the key values that are repeatedly input are identical to each other; and transmitting, when input of all of the keys provided on the universal remote controller is completed, a completion of the learning by voice information and registering the control codes matching with the learned key values according to detection of a confirm key.

### ADVANTAGEOUS EFFECTS

As described above, since the universal remote controller of the present invention further includes a voice recognition function and a voice message transmission function, the setup of the control codes or the learning of the control codes are preformed in accordance with voice information that is sequentially provided from the universal remote controller, thereby making it convenient to set up the control codes or learn the control codes. This function is referred to as a “FOLLOW ME FUNCTION”.

### DESCRIPTION OF DRAWINGS

FIG. 1 is a schematic diagram of a universal remote controller according to an exemplary embodiment of the present invention.

FIG. 2 is a flowchart illustrating a method for learning control codes of an appliance that will be controlled according to an exemplary embodiment of the present invention.

FIG. 3 is a flowchart illustrating a method for setting up control codes in accordance with voice information in a universal remote controller according to an exemplary embodiment of the present invention.

FIG. 4 is a top plan view of a universal remote controller according to an exemplary embodiment.

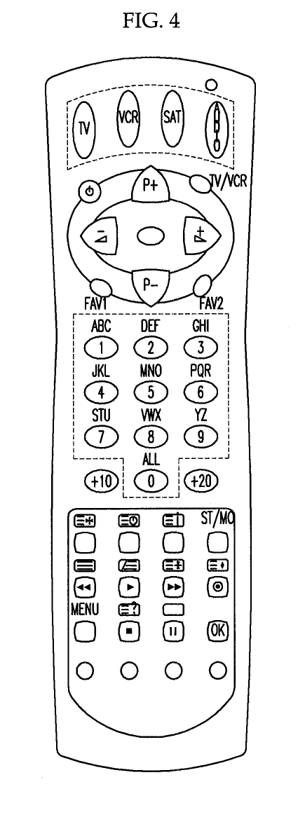

### BEST MODE

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

A universal remote controller and a control codes setup method thereof according to an exemplary embodiment of the present invention will be described in detail with reference to the accompanying drawings.

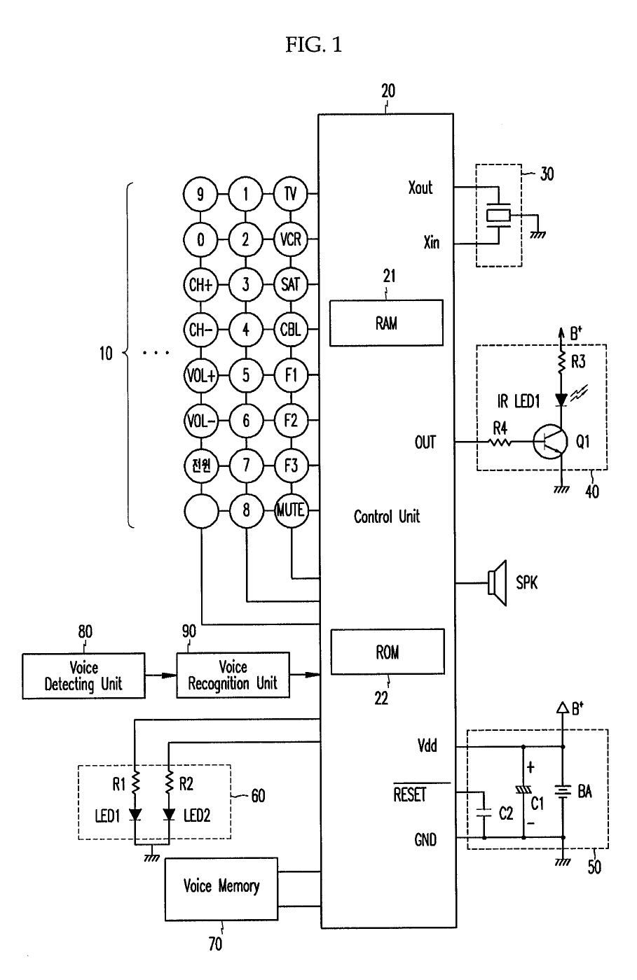

FIG. 1 is a schematic diagram of a universal remote controller according to an exemplary embodiment of the present invention. Referring to FIG. 1, a universal remote controller includes a key input unit 10, a control unit 20, an oscillation unit 30, a transceiver unit 40, a power unit 50, a display unit 60, a voice memory 70, a voice detecting unit 80, a voice recognition unit 90, and a speaker Spk.

The key input unit 10 includes a plurality of matrix contact points defined by intersections of X and Y axes. A typical output voltage is set on each contact point. When a user selects one of the contact points, a voltage drop occurs to apply the typical voltage of the selected contact point to the control unit 20 so that the control unit 20 can identify a selected key valve.

The key input unit 10 includes keys TV, VCR, SAT, CBL for selecting an appliance that will be controlled, a power key, channel keys CH+ and CH−, sound up/down keys VOL+ and VOL−, a mute key, and a plurality of number keys 0-9 for selecting a channel number.

Although not shown in the drawing, the key input unit 10 may further include a light on/off key, a curtain opening/closing key, an air conditioner on/off key, and the like.

The control unit 20 is a microprocessor that controls general operation for the remote control of the appliance, provides sound information on a control codes setup method step by step through a speaker Spk when a control codes setup mode is started, recognizes a key signal or a voice command input by the user in accordance with the voice information, temporarily stores the control codes of the appliance that match with the key signal in a RAM 21, and confirms and stores the control codes when it is confirmed that the control codes setup is completed.

In addition, in the control codes learning mode, the control unit 20 provides the voice information step by step through the speaker Spk and learns and stores the control codes input from the controller of the appliance in a RAM 21.

The control unit 20 provides the control codes setup method for the appliance in the form of a user manual type using the voice information through the speaker Spk, recognizes the key signal or voice command input in accordance with the voice information, and continuously provides an input order using the voice in the form of a sub-directory manual.

When the input of the voice command is detected, the control unit 20 stores the currently input voice command in a corresponding address region in accordance with the voice information transmitted and registers the current voice command as a new voice command.

For example, a voice command for controlling opening/closing of a curtain is learned and registered in an address region of a voice command that is set to control an air conditioner,

The control unit includes a ROM 22. An operation program for remote-controlling the appliance and a control table of codes for different appliances by different manufacturing companies are set in the control unit 20.

The oscillation unit 30 oscillates a frequency of a predetermined band to operate the control unit 20.

The transceiver unit 40 transmits control codes to the appliance in accordance with a control signal of a square wave pulse applied from the control unit 20 and receives and learns control codes from a controller.

The transceiver unit 40 includes a resistor R4 adjusting an intensity of an output signal, a transistor Q1 that is switched in accordance with a signal applied to a base terminal through the resistor R4 and connected to an emitter by a ground, and an infrared light emitting diode that emits light by power applied through a resistor R3 in accordance with a switching operation of the transistor Q1 to transmit the control codes.

The transceiver unit 40 is designed to transmit and learn the control codes using the infrared light. However, the present invention is not limited to this configuration. That is, a radio frequency may be used to transmit the control codes.

The power unit 50 is a power source of a controller device. The power unit 50 supplies a voltage of a primary or secondary battery to the control unit 20 or other load sides as an operating power. The power unit 50 includes first and second condensers C1 and C2 that are electrolyte condensers performing charging/discharging operations by being connected in parallel to an output terminal of the power source.

The display unit 60 includes one or more light emitting diodes. When one of the keys of the key input unit 10 is selected or a designation mode (a specific key such as a preference channel) is set, or a control code of the appliance that will be controlled is set in accordance with an information message, the display unit 60 displays the corresponding information to the user by turning on/off a predetermined number of times.

The voice memory 70 stores voice data for guiding a control codes setup method of the appliance by learning the control codes of the appliance, setting the designation mode (a specific key such as a preference channel or the like), and applying control codes for each appliance that are stored in the ROM 22.

The voice detecting unit 80 may be, for example, a microphone Mic. The voice detecting unit 80 detects a voice command requesting the control codes setup or the learning of the control codes and a voice command input in accordance with the voice information transmitted from the speaker Spk.

The voice recognition unit 90 extracts components of voice signals distributed in a specific band from the voice signals having an ambient noise through a band rejection filtering process to increase the recognition rate of the voice command and provides the recognized voice command to the control unit 20 so that the learning or setup of the control codes can be achieved.

The voice recognition unit 90 learns a user's voice commands having different voice colors and accents by ages and provinces using a personal independent method to correct a recognition rate difference of a variety of voice commands according to voice properties such as voice level, accent by province, and the like, performs a modeling of an optimal value, and processes a voice difference between individuals as an identical key value by applying the optimal value.

The universal remote control having the above-described functions according to an exemplary embodiment of the present invention sets up the control codes in accordance with voice information according to the following processes.

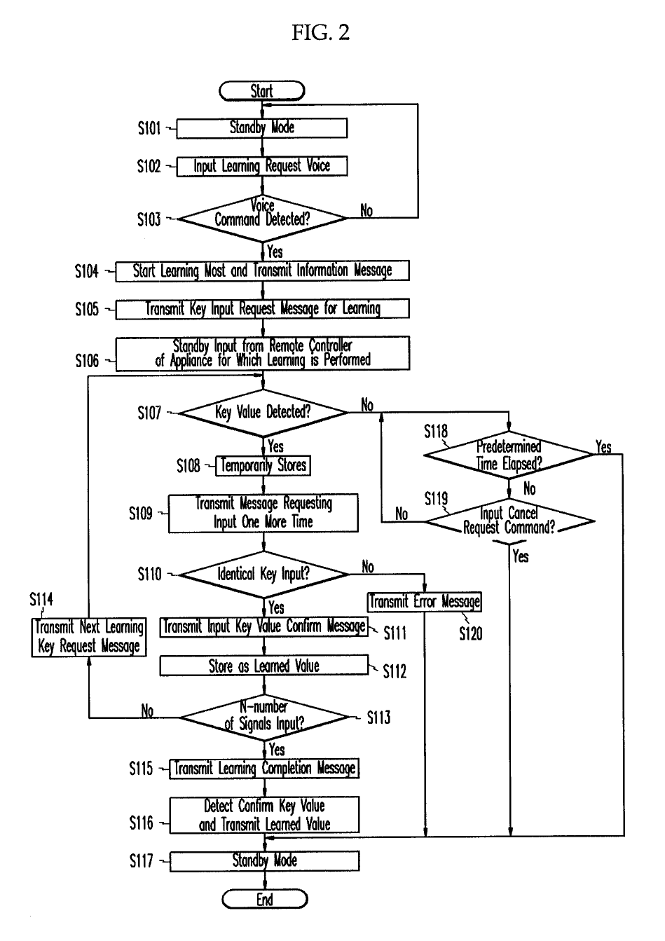

The following will describe a method for learning and setting up the control codes transmitted from a controller of an appliance that will be controlled with reference to FIG. 2.

When there is a need to learn the control codes of the appliance in a state where the universal remote controller maintains a standby mode (S101), a voice command requesting the learning, e.g., “input appliance signal”, or a key signal designating the learning mode is input (S102).

At this point, the voice detecting unit 80 provided in the universal remote controller detects the user's voice command and transmits the same to the voice recognition unit 90. The voice recognition unit 90 recognizes the voice command requesting the learning of the control codes applied from the voice detecting unit 80 and transmits the same to the control unit 20.

The voice recognition unit 90 repeats the sampling process to increase the recognition rate of the voice command containing the noise and extracts components of the voice signals distributed in a specific band through the band rejection filtering process, thereby stably recognizing the voice command.

The control unit 20 analyzes the signals transmitted from the voice recognition unit 90 and determines if the voice command requesting the learning of the control codes key signals are detected (S103).

When the voice command or the key signals are not detected in step S103, the process is returned to step S101 to maintain the standby mode. When the voice command or the key signals are detected in step S103, the control unit 20 repeatedly transmits the voice command, e.g., “input appliance signals”, starts the learning mode, accesses data for informing the start of the learning mode from the voice memory 70, and outputs the same by the voice information through the speaker Spk. (S104).

After the above, the control unit 20 accesses voice data requesting the key input for the learning from the voice memory 70 and transmits the same by the voice information through the speaker Spk (S105), after which the control unit 20 waits for the key input of the controller of the appliance (S106).

The voice command transmitted in step S105 may be, for example, “press the keys of the controller of the appliance whose control codes will be set up in accordance with the guide message in order”.

Therefore, the user first pushes the power key of the controller for which the control codes will be learned and thus a control code corresponding to the power key is transmitted. Therefore, the control unit 20 determines whether the key value is transmitted from the controller of the appliance through the transceiver unit 40 (S107).

When the key value is not detected within a predetermined time in step S107 or a voice command requesting cancellation of the learning mode is detected (S119), the learning mode for the control codes is canceled and the process goes to the standby mode (S117).

When the key value transmitted from the controller of the appliance is detected in step S107, the key value is temporarily stored in the RAM 21 (S108) and a voice command requesting selection of the key one more time is transmitted through the speaker Spk to enhance the learning reliability (S109).

For example, a voice command such as “select at least one more time the key input” is transmitted.

Therefore, the control key, e.g., the power key, is selected at least one more time by the user and subsequently the learning of the control code corresponding to the power key is performed through the above-described process.

It is identified whether the control codes detected at least two times by transmitting the guide message are for the identical key (S110). If the control codes are not for the identical key, it is determined that learning of the control code has been abnormally performed and thus an error message is transmitted (S120), after which the process is returned to step S117.

The error message may be voice information such as “the learning mode will end since there is an error in the key selection”.

When it is determined that input of the identical key is detected at least two times in step S110, voice information confirming the key value input is transmitted through the speaker Spk (S111), after which the key value is stored as the learned value (S112).

The voice information in step S111 is to confirm which key has been input, and thus may be, for example, “input of the power key is detected” and “this will be stored as the learned value”.

After the above, it is determined whether learning for all of the keys, including the power key, channel up/down keys, sound up/down keys, number keys, and the like, has been sequentially performed (S113).

When it is determined that learning for all of the keys has not been performed, voice information requesting input of the next key is sequentially transmitted through the speaker Spk, after which the process is returned to step S107 to repeat the above-described processes, thereby detecting and learning the key values (S114).

When it is determined that the sequential learning for all of the keys has been performed, the control unit 20 accesses voice data guiding the learning completion and control codes setup from the voice memory 70 and transmits the same as a voice through the speaker Spk (S114).

For example, voice information such as “learning of the control codes for the controller of the appliance is completed” is transmitted.

When the input of the key value set to confirm the storing of the learned control codes from the key input unit 10 is detected in step S115, the learned values stored in the RAM 21 are stored as the control codes (S116), after which the process goes to the standby mode (S117).

As described above, the universal remote controller of the present invention provides convenience and reliability in learning the control codes using the controller of the appliance by starting the learning mode by inputting the voice command and operating the controller of the appliance in accordance with the voice information that is sequentially provided in the form of the manual type from the universal remote controller.

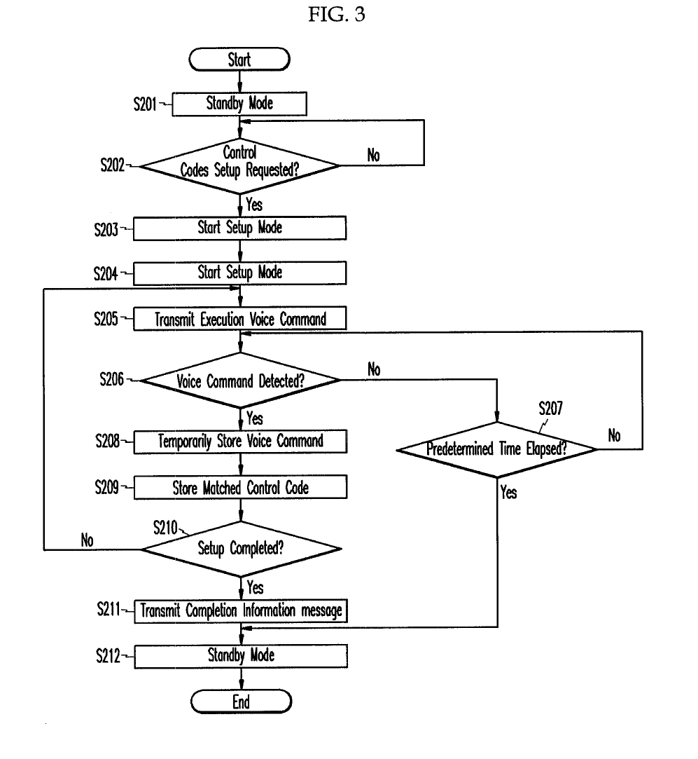

As another exemplary embodiment of the present invention, a method for setting control codes by transmitting voice information guiding the learning and recognizing key signals or voice commands in accordance with the transmission of the voice information will be described with reference to FIG. 3.

In a state where the universal remote controller of the present invention maintains the standby mode (S201), the controller 20 determines whether a voice command requesting the start of the control codes setup mode, which is provided through the voice detecting unit 80 and the voice recognition unit 90, is detected or the input of a specific key of the key input unit 10, i.e., the key designating the control codes setup, is detected (S202).

The voice command requesting the start of the control codes setup mode may be, for example, “set up a control code voice”.

When the voice command requesting the control codes setup or the input of the specific key is not detected in step S202, the process is returned to step S201 to maintain the standby mode. When the voice command requesting the control codes setup or the input of the specific key is detected, the control unit 20 starts the control codes setup mode (S203).

After the above, the control unit 20 accesses a guide message stored in the voice memory 70 and transmits the voice information confirming the start of the control codes setup mode through the speaker Spk (S204).

Further, the control unit transmits voice information on the control codes setup method through the speaker Spk (S205).

For example, voice information such as “input a voice command or key signal in accordance with the voice guide” is transmitted.

When the voice information is transmitted as described above, the control unit 20 determines if the input of the voice command in accordance with the voice guide is detected through the voice detecting unit 80 and the voice recognition unit 90 or if the input of the key signal in accordance with the guide voice is detected (S206).

That is, the control unit 20 of the universal remote controller transmits voice information such as “turn on TV” through the speaker Spk and determines if the voice command “turn on TV” is input by the user.

When the input of the voice command by the user or the input of the key signal is not detected in step S206, that is, when the input of the voice command or the input of the key signal in accordance with the voice information transmitted through the speaker Spk is not detected, a time that has been elapsed after the transmission of the voice information is counted and it is determined whether a predetermined time has elapsed (S207).

When it is determined that the predetermined time has not elapsed in step S207, input of the voice command by the user or input of the key signal is continuously detected. When the predetermined time has elapsed, the control codes setup mode is finished and the standby mode is started (S211).

When input of the voice command by the user or input of the key signal is detected, e.g., when input of “turn on TV” by the user in accordance with the voice command “turn on TV” transmitted through the speaker Spk is detected, the voice command is temporarily stored in the RAM 21 (S208).

Thus, the key signal input according to the voice information is determined as the power key and this is temporarily stored in the RAM 21.

After the above, the key signal or the voice command input by the user and stored in the RAM 21 is matched with the control code value and the matching value is stored as the control code of the appliance that will be controlled.

When the storing of the control code value matching with the voice command or key signal input by the user is completed, the control unit 20 determines if all of the control codes for the appliance that will be controlled are set (S210).

That is, it is determined whether the setup of all of the control codes has been completed by the transmitting of all the voice information set in the voice memory and the inputting of all the voice commands or all the key signals by the user.

When the setup of the control codes is not completed in step 210, the process is returned to step S205 to transmit the voice information for the setup of the next control code and the control code is set in accordance with the voice command or key signal that is input by the user according to the transmitted voice information.

When it is determined in step S210 that the setup of all the control codes for the appliance is completed, the control unit 20 transmits voice information informing that the learning is completed through the speaker Spk and the process goes to the standby mode (S212).

For example, a guide message such as “setup of the control codes for TV is completed” is transmitted.

Using the above-described process, the control codes for other appliances, such as VCR, SAT, CBL, home automation, home network, and the like, can be set.

Further, when a specific channel is registered as a preference channel, the voice information and the voice command or key signal that is input in accordance with the voice information can be recognized and registered.

In addition, the voice information transmitted through the speaker Spk in step S205 is realized in the form of a manual type for the control codes setup method. When a specific menu is selected, sub-directories according to the selected menu are sequentially selected and informed by voice.

In the above description, a case where the control codes matched with the key signals or the voice commands input by the user according to the voice information are registered is explained.

However, a method for storing control codes matching with currently input voice commands or key signals in a corresponding address region of the voice information when the voice commands or key signals input by the user according to the voice information transmitted through the speaker Spk are input by a voice command different from the voice information is within the scope of the present invention.

For example, when the voice information “turn on VCR” is transmitted but a voice command “turn on a rest room light” is input by the user, the control code “turn on a rest room light” is registered and stored in the address region where the control code “VCR” is stored.

When there is no need to input all of the keys provided on the universal remote control, the control unit 20 skips sequentially the key input and transmits the voice information on the next setup and the request of the next setup, after which the control unit 20 recognizes the voice command or key value input by the user according to the voice information and stores and registers the control code matching with the voice command and key value. This method is also within the scope of the present invention.

What is claimed is:

1. A universal remote controller comprising a key input unit having at least one function key and number key, an oscillation unit oscillating at a predetermined frequency, a power unit supplying power to loads, a transceiver unit for transmitting and receiving control codes, and a display unit displaying an operational state, wherein the universal remote controller further comprises:
a voice memory storing voice data informing a control codes setup method;
a sound detecting unit detecting a voice command;
a voice recognition unit recognizing the voice command transmitted from the voice detecting unit; and
a control unit that starts a control codes setup mode by recognizing the voice command or key signal, transmits a setup of the control codes by voice information through a speaker, stores the control codes matching with the voice commands or key signals input by a user according to the voice information.

2. The universal remote controller of claim 1, wherein a modeling value obtained by repeatedly learning a user's voice commands having different voice colors and different accents by ages and provinces through a personal independent method is set in the voice recognition unit to correct a recognition rate difference of the voice commands of individuals having different voice levels and different accents by provinces.

3. The universal remote controller of claim 1, wherein the controller transmits a user manual that is the control codes setup method for an appliance that will be controlled through the speaker by the voice information, stores the control codes matching with the voice commands or key signals input by the user according to the voice information, and sequentially provides sub-directory manuals.

4. The universal remote controller of claim 1, wherein, when a voice command or key signal designating another appliance or performance of another operation to the voice information transmitted is detected, the control unit stores a control code of the current input voice command or key signal in a corresponding address region and registers the control code of the currently input voice command or key signal as a new control code.

5. The universal remote controller of claim 1, wherein the control unit sets the key signal input according to the voice information transmitted as the control code and stores the control code.

6. A control codes setup method of a universal remote controller, comprising:
detecting input of a voice command or a specific key signal requesting control codes setup in a standby mode;
starting, when the voice command or specific key signal is detected, a control codes setup mode and transmitting a control codes setup method step by step by a voice information;
recognizing a voice command or key signal input by a user according to the voice information transmitted; and
starting a standby mode after registering and storing the control codes matching with the recognized voice commands or key signals and transmitting the voice information on the registering and storing of the control codes.

7. The control codes setup method of claim 6, wherein the voice command is recognized repeatedly at least two times for recognition accuracy.

8. The control codes setup method of claim 6, wherein, when the voice information is different from the voice command input according to the voice information, a currently recognized voice command “ ” “ ” is registered as the control code in a corresponding address region (e.g., “turn on VCR” is learned as “turn on the light of a rest room”).

9. The control codes setup method of claim 6, wherein, when the input of the voice command corresponding to the voice information transmitted is not detected for a predetermined time in a state where the control codes setup mode is started, the control codes setup mode ends and the standby mode is started.

10. The control codes setup method of claim 6, wherein the voice information transmitted in the control codes setup mode provides the control codes setup method in the form of a user manual type, recognizes the voice command input according to the voice information and registers the voice command as the control code, and sequentially provides sub-directory manuals.

11. A control codes setup method of a universal remote controller, comprising:
starting a learning mode when a voice command or key signal requesting control codes learning is detected in a standby mode, informing the start of the learning mode by a voice information, and requesting a key input corresponding to the voice information;
learning and storing a key value input according to the voice information and requesting input of the corresponding key at least one more time for reliability;
determining if the key values that are repeatedly input are identical to each other;
starting the standby mode after transmitting an error message when the key values that are repeatedly input are not identical, or transmitting the key value and storing the key value as a learned value when the key values that are repeatedly input are identical to each other; and
transmitting, when input of all of the keys provided on the universal remote controller is completed, completion of the learning by voice information and registering the control codes matching with the learned key values according to detection of a confirm key.

12. The control codes setup method of claim 11, further comprising, when there is no need to input all of the keys in the control codes setup, sequentially skipping the key input, transmitting the voice information on the next setup and the request of the next setup, learning a new key value input accordingly, and registering a control code corresponding to the new key value.

13. The control codes setup method of claim 11, wherein, when the learning mode is started, the control codes setup method of the appliance that will be controlled is provided as a user manual by a voice information and sub-direction manuals are sequentially provided according to a selected key when a specific key input is detected according to the providing of the user manual.
